(19) United States
(12) Patent Application Publication
(10) Pub. No.: US 2007/0179683 A1
(43) Pub. Date: Aug. 2, 2007

(54) Emissions Management System

(76) Inventor: Lotenna OKEKE, Edinburgh (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/569,484

(22) PCT Filed: May 16, 2005
(86) PCT No.: PCT/GB05/01872

§ 371 Date: Nov. 21, 2006

(30) Foreign Application Priority Data
May 21, 2004 (GB) 0411353.6

(51) Int. Cl. G01M 17/00; G06F 17/00

(52) U.S. Cl. 701/1; 701/33; 701/35

(57) ABSTRACT

An emissions management system comprising a network with a plurality of software modules interconnected such that each software module is able to communicate with at least one other software module, and memory means, wherein at least one software module is configured to: communicate with at least one sensor system collecting real-time emissions data from at least one emitting facility; store emissions data captured from the sensor system in the memory means, and make at least a portion of the stored emissions data available to at least one other software module in the network.

The present invention relates to a method and an apparatus for collecting and distributing emissions data. More particularly, though not exclusively, the invention relates to managing emissions from a multiplicity of emitters using real-time emissions data.

Climate change and global warming are serious issues that affect our planet, for this and future generations. Global warming is a natural phenomenon in which the sun's heat reflected from the surface of the earth is trapped in the atmosphere. This process is entirely natural: without it there would be no life on earth. Global warming is the term given to the enhancement of this process: this ‘greenhouse’ effect has been linked to mankind's activities mainly from the burning of fossil fuel. Climate change can lead to considerable social damage such as flooding, sea encroachment, drought, etc. Evidence is mounting that this is already happening. Due to the seriousness of this issue global and regional governments are reacting with legislation and policy to combat climate change and global warming.

The EU Commission in particular is actively responding to the challenge of global warming by issuing The EU Emissions Trading Directive, which was agreed in July 2003 and came into force in September 2003. Emissions Trading is now a reality and will come into full force on the 1, Jan. 2005. Emissions Trading is an economic policy instrument which aims to achieve a reduction in the emissions of greenhouse gases. It works by capping the aggregate amount of emissions emitters can emit. Details will be contained in the emitter's European permit license e.g. the allowed amount of CO₂ to be emitted is represented by the amount of allowances allocated to the installations. By allowing emitters to trade these allowances between themselves, efficiency gains can be made and it has been proven that reductions in greenhouse gas emissions will happen at the lowest cost.

Commercial software packages/applications are currently available for enabling a single emitter to monitor and evaluate their own emissions and/or to model future emissions and/or produce data reports on the company's emissions. Examples of such packages include “Emissions logic” from CarbonSim and LogicaCMG, and EmControl from Carbon Market Solutions. Such packages tend to be stand-alone pieces of software which a company can install in-house for analysing their own emissions data. The company must then somehow communicate individually with other companies if they wish to try to obtain emissions data from such other companies and/or if they wish to try to trade emissions allowances with such other companies. Other on-line software applications are available which aim to provide companies with market intelligence and forecasting e.g. Carbon Market Trader from Point Carbon. Such systems tend to be based on estimated emissions rather than actual real-time emissions data.

It is an aim of the present invention to avoid or minimise one or more of the foregoing disadvantages.

According to a first aspect of the present invention there is provided an emissions management system comprising a network in which a plurality of software modules are interconnected such that each said software module is able to communicate with at least one other said software module, wherein at least one said software module is configured to: communicate, directly or indirectly, with at least one sensor system collecting real-time emissions data from at least one emitting facility, so as to capture on a substantially real-time basis emissions data so collected, and store said captured data in memory means provided in the emissions management system, and make at least a portion of said stored emissions data available to at least one other said software module in the network.

Preferably the network comprises a main server system in a first location and supporting said plurality of software modules. The main server system of the network is preferably configured and/or programmed so as to communicate with a plurality of remote computer systems running in a plurality of further locations. At least a portion of one or more of said software modules may be programmed into a memory of one or more of said remote computer systems. At least one or more of said remote computer systems may include a said sensor system for collecting real-time emissions data from an emitter facility at its respective location. For example, the remote computer systems may be installed in different emitter facilities (e.g. different companies) respectively, and/or may include systems installed in premises owned by industry regulators (e.g. government controlled departments) and/or market analysts. Advantageously, the main server system is programmed with software code configured to control the flow of data between the remote computer systems in communication therewith.

One advantage of the inventive system is that real-time emissions data, collected from one or more emitter facilities, is immediately available to the network for processing to provide useful emissions information to operators, regulators and/or the emitters themselves, such as data/information representing the current state of emissions at each emitter facility. (The state of emissions may be expressed in any predetermined format e.g. quantity of emissions since a predetermined date or time.) Thus, at any given moment in time, an authorised party with access to the network can find out information representing the current state of emissions at a given emitter facility at that moment in time. This enables the regulators to carry out accurate monitoring of emissions from one or more emitting facilities and enables different emitter facilities to make emissions trading decisions based on real-time emissions data. This, in turn, leads to the overall beneficial effect of a reduction in emissions.

The plurality of software modules may include a first software module comprising an emissions monitoring system for capturing and storing real-time emissions data from a plurality of emitters, and making the stored emissions data available to one or more of said other software modules on a real-time, or substantially real-time, basis. The first software module may additionally be configured to process said captured emissions data before making the captured data available to the other software modules.

The plurality of software modules may further include a second software module comprising a reporting, monitoring and ordering system for performing monitoring and analysis of emissions from one or more emitters from which real-time emissions data has been captured and stored by said first software module. The second module is preferably configured to process the real-time emissions data collected from each said emitter so as to identify one or more trends in the emissions of said emitters. Preferably the second module is also configured to produce a report on the identified emissions of a said emitter when prompted to do so by a user of the emissions management system. The second module may be configured to display the report(s) on a display screen and/or to print the reports on a printing means provided in the system and/or to simply make selected data from the report available to one or more of the other software modules in the network.

The plurality of software modules may further include a third software module comprising a central monitoring system for monitoring compliance of emitters with emissions regulations and/or for regulating emitters. For example, the third module may be configured to analyse data stored and/or processed by the first and/or second module so as to detect emitters who are failing to comply with a predetermined emissions regulation (e.g. if the third module detects that a predetermined allowed level of emissions has been exceeded). The third module may additionally be configured to automatically issue a warning letter or alarm (e.g. an email alarm message) or other communication to such an emitter and/or to issue a penalty charge notice to such an emitter.

The plurality of software modules may further include a fourth software module comprising an electronic emissions trading system for enabling emitters to trade emissions allowances. For example, the fourth module may be configured to receive orders from emitters who wish to trade emissions allowances, and to make said orders available for viewing by other users of the system.

The plurality of software modules may further include a fifth software module comprising a verification and/or certification system for use by verifiers/auditors and/or certifiers of emitters. The fifth module is preferably configured to communicate with the second module to obtain and analyse emissions information relating to one more emitters. This system has the advantage that verifiers/certifiers can easily access remotely emissions data and information relating to the emitters who have provided emissions data for capture and storage by the first software module.

The plurality of software modules may further include a sixth software module comprising an electronic auction system. The auction system may, for example, be designed for use by regulators (such as government departments) who wish to auction surplus emissions allowances to interested emitters.

Finally, the plurality of software modules may further include a seventh software module comprising an internet (i.e. World Wide Web) website for providing emissions information to the public. The website may be configured to provide news and/or other information to emitters, members of the public and any other interested parties. The seventh module may be configured to communicate with the second module so as to extract information about emitter emissions for display to users of the website (either automatically or when prompted to do so by a user).

For the avoidance of doubt, the emissions management system need not include all seven of the above described software modules: it may include any two or more of the described modules, but preferably it includes at least the above-described first and second modules. Additionally, the system may include one or more further software modules carrying out other functions, if desired.

The software modules may be written in any suitable software code, for example Micrososft™ C++, Visual Basic and/or Micrososft.NET. Programmers skilled in the art will be knowledgeable in the relevant software code and will readily know how to implement the above-described system in appropriate code. Therefore there is no need herein to describe the system at code level.

According to a second aspect of the invention there is provided a method of providing real-time emissions data relating to at least one emitting facility in a first physical location to a plurality of parties located in a plurality of different physical locations remote from the first physical location, wherein the method comprises the steps of: collecting real-time emissions data from at least one emitting facility; uploading at least some of the collected emissions data to a computer network; capturing and storing the uploaded data in a memory means of the network, on a substantially real-time basis; and making at least a portion of the stored information available to said plurality of parties via the network. Optionally, the stored information, or at least a portion of the stored information, may be made available to one or more predetermined ones of said plurality of parties on a real-time, or substantially real-time, basis.

The method may further include providing sensor systems to one or more emitting facilities for collecting real-time emissions data from the respective facilities.

Preferably, the network comprises a main computer server system programmed with software code for processing the captured real-time emissions data prior to making it available to the plurality of parties. The method may further include processing the captured real-time emissions data so as to identify failure of an emitter to comply with emissions regulations and may further include automatically issuing a warning and/or penalty charge communication to such an emitter.

The method may include processing the real-time emissions data captured from an emitting facility and automatically alerting the emitting facility when emissions exceeding a predetermined threshold value are exceeded, or are about to be exceeded, whereby the emitting facility can reduce its emissions so as to reduce overall greenhouse gas emissions.

One embodiment of the invention will now be described by way of example only and with reference to the accompanying drawings in which:

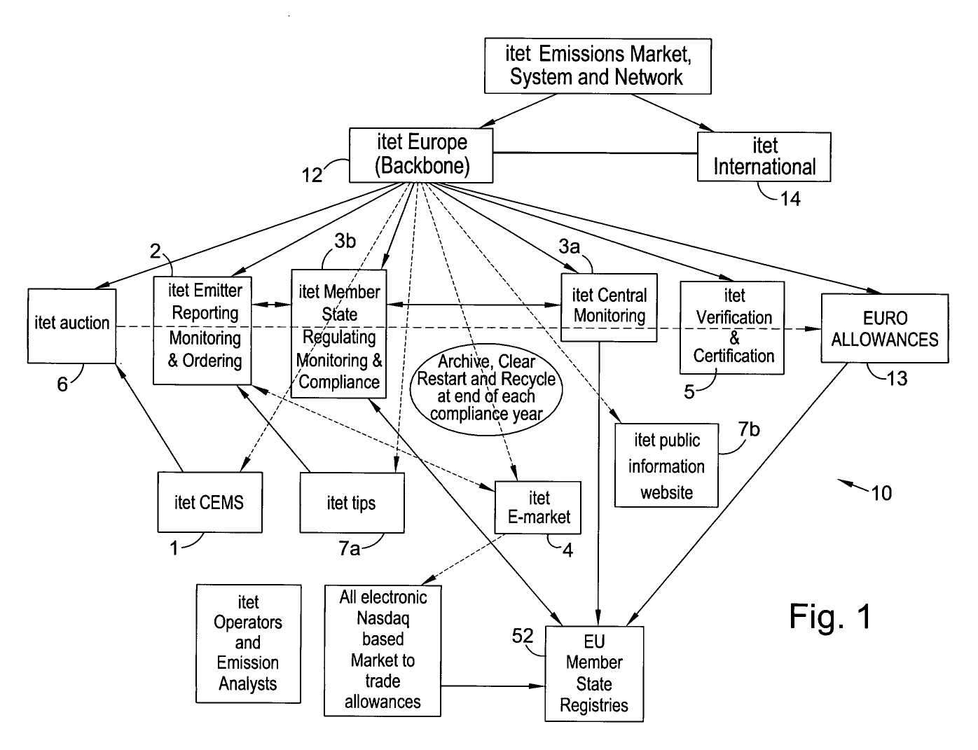

FIG. 1 is a block diagram of an emissions management system according to one embodiment of the invention;

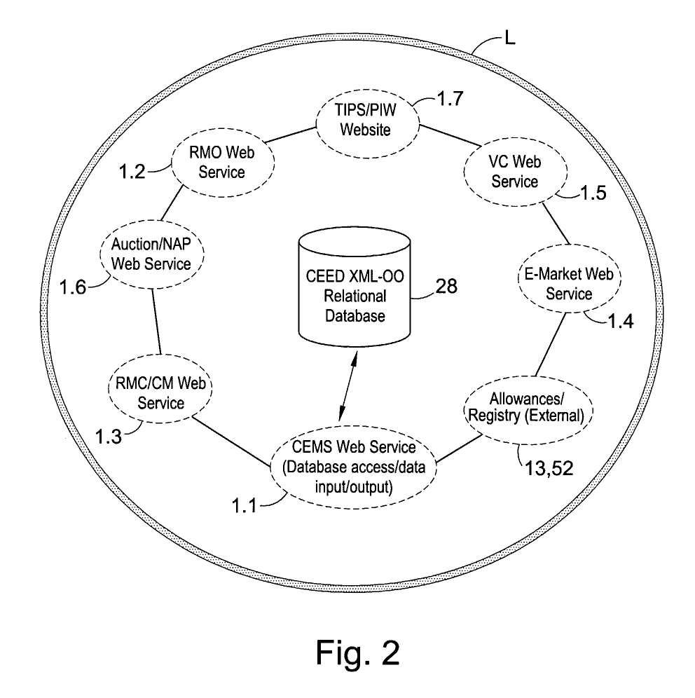

FIG. 2 is a schematic overview of various networked components of the system of FIG. 1;

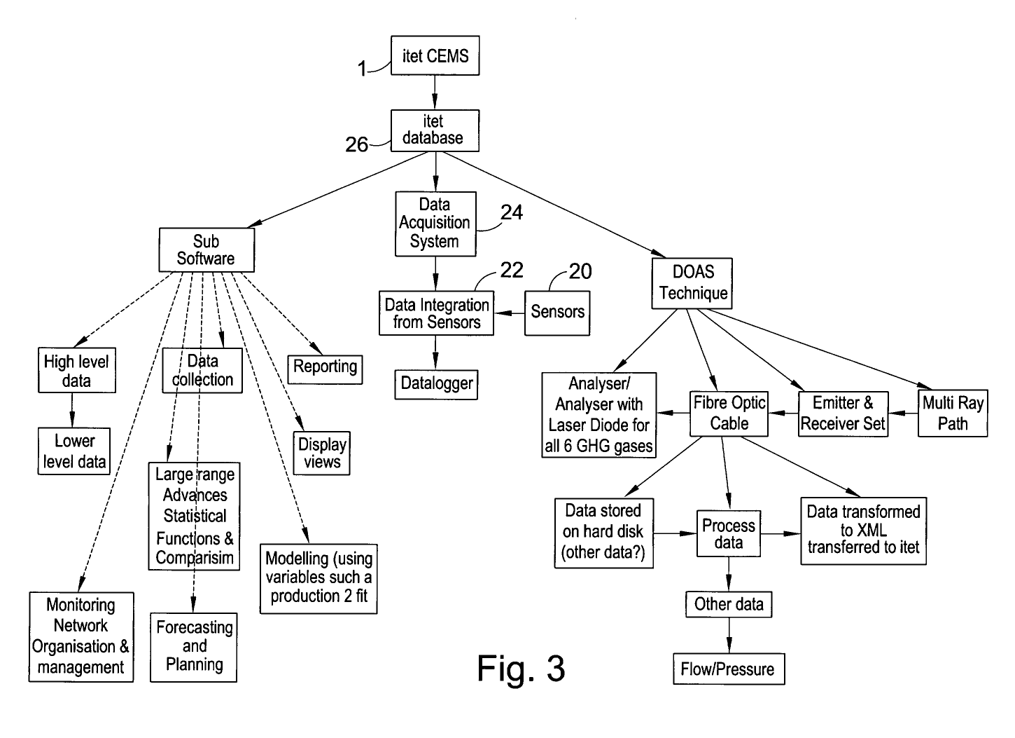

FIG. 3 is a block diagram illustrating a first software module of the system of FIG. 1;

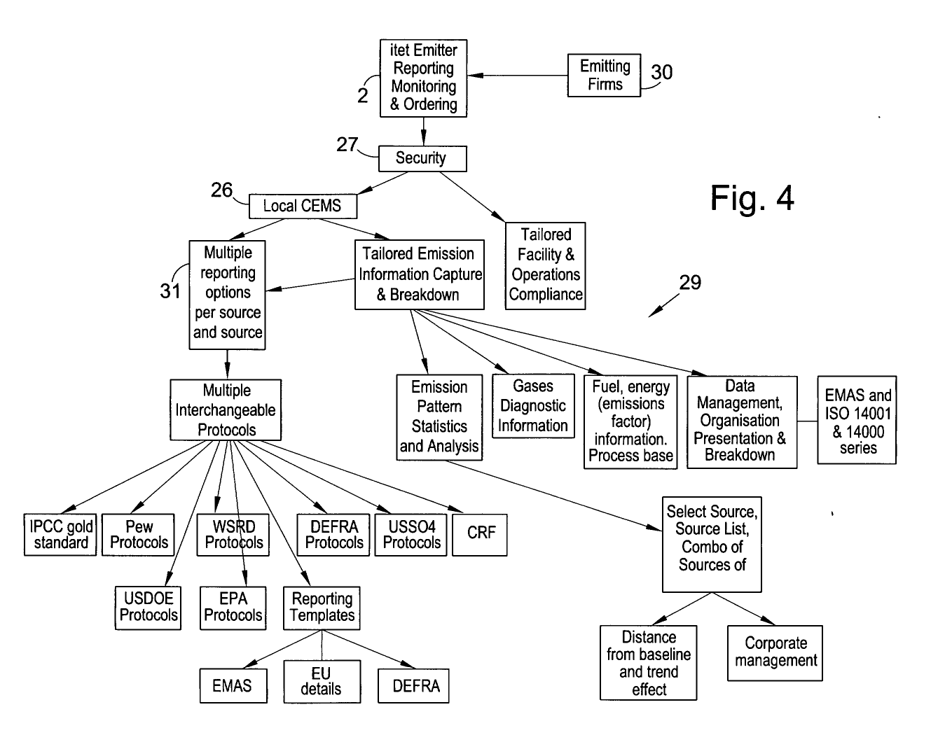

FIG. 4 is a block diagram illustrating a second software module of the system of FIG. 1;

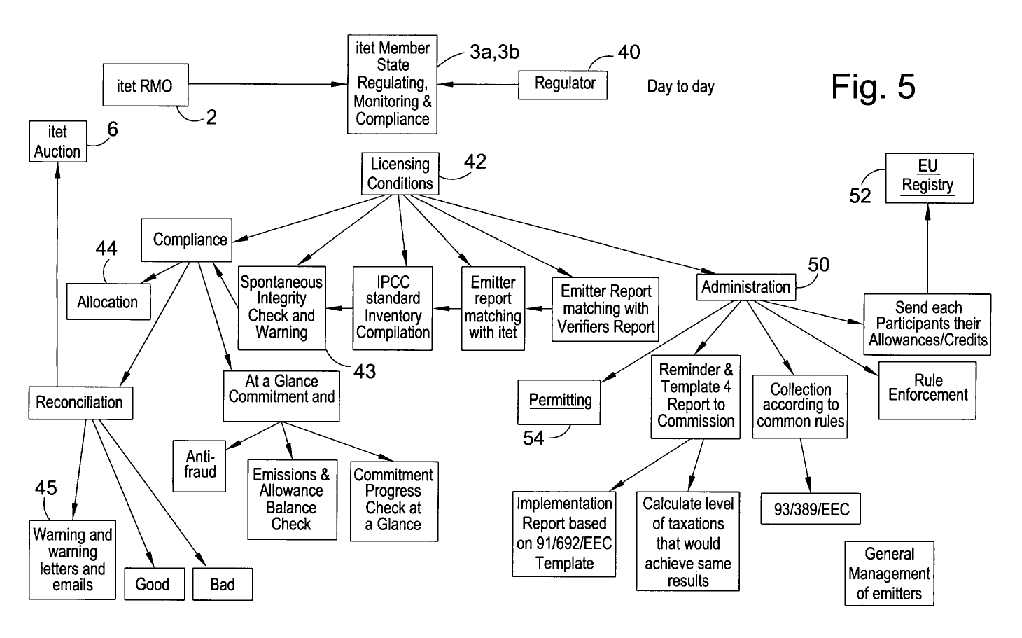

FIG. 5 is a block diagram illustrating a third software module of the system of FIG. 1;

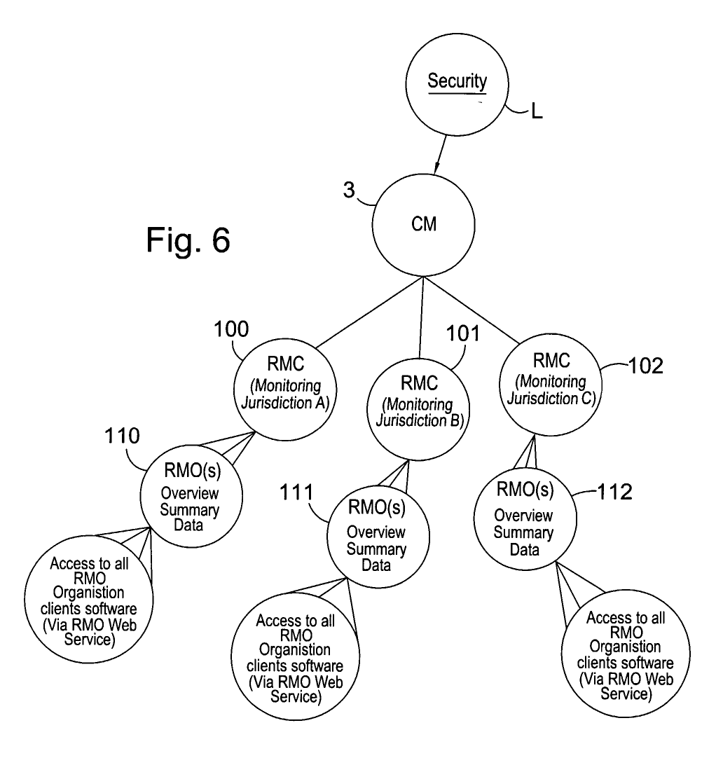

FIG. 6 is a schematic diagram illustrating the operational relationship of the second and third software modules of the system of FIG. 1, at programming level;

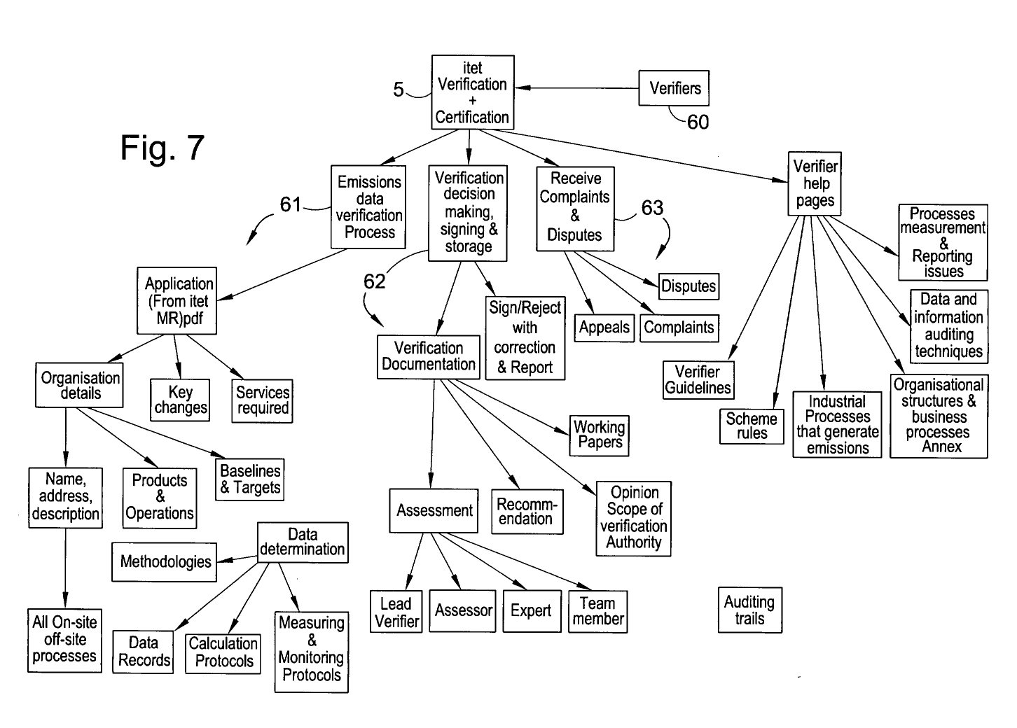

FIG. 7 is a block diagram illustrating a fifth software module of the system of FIG. 1; and

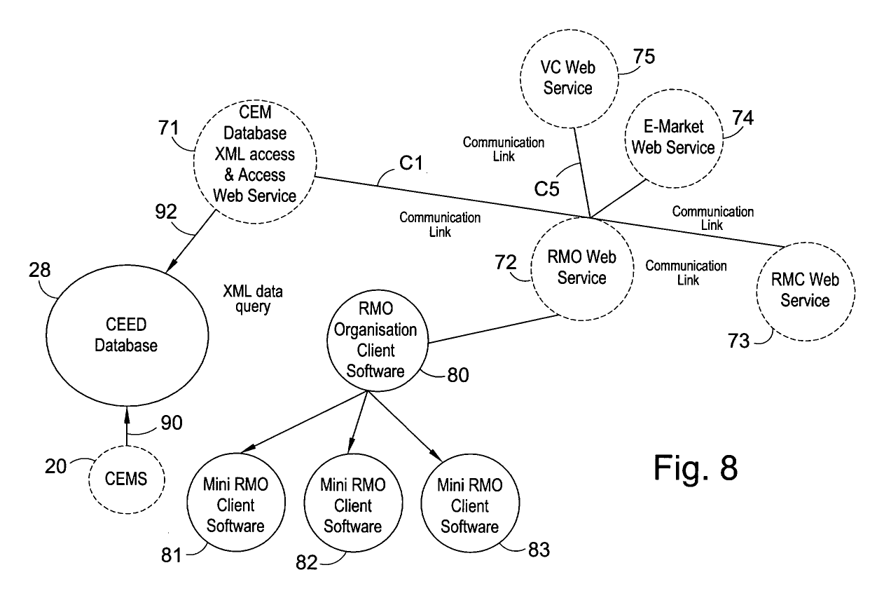

FIG. 8 is a schematic diagram illustrating the operational relationship of various components of the system of FIG. 1, at programming level.

FIG. 1 illustrates in block diagram form the various components of a software network 10 for managing emissions from a plurality of emitting facilities (also sometimes referred to herein as “emitters”). The network comprises seven software components or “modules” 1-7 communicating within the software network 10. These are as follows: 1.1 CEMS Database; 1.2 RMO; 1.3 CM/RMC; 1.4 E-Market; 1.5 VC; 1.6 Auction, and 1.7 TIPS/PIW.

Each of the seven components 1.1 to 1.7 is represented by a respective web service server on a Microsoft.NET Web Services framework. This is illustrated schematically in FIG. 2 which shows the seven web servers connected as a network that is protected by a security layer L. The security layer L is implemented in the form of dedicated and specialised programs, including Firewalls, encryption technology, user authentication and identification software, anti-virus and network access software. Suitable products which perform this security level function are available on the market, for example from RSA Security Ltd. Each emitting facility or other party wishing to access the network must do so through complementary “client” programs/software running in their own respective local computer system. In practice, when each user is set-up to use the network they will be allocated a certain level of security clearance which determines the level of access the user will have to information on the network (e.g. full or partial access). This is done for data protection reasons and to allow protection of sensitive (e.g. commercially sensitive) information.

We shall refer to this network system as the Information Technology Emissions Trading (itet) system. There now follows a description and overview of the seven itet network software operations and how they work together.

1.1 CEMS Database (See FIGS. 1 and 3)

The CEMS Database 1 forms the working heart of the itet network. CEMS stands for Continuous Emissions Monitoring System and it delivers the real time emissions data. Data is at the heart of any Emissions Trading Program: a system that accurately captures, stores and transfers it is indispensable. CEMS sensors 20 are provided by suppliers and integrated to the network 10 using a patch which, in this embodiment, encodes data from the sensors into the computer language “XML” and transmits the encoded data on to the network 10. Each sensor 20 makes real-time measurements of emissions in the facility/installation in which the sensor is installed. Real-time emissions data (i.e. measurements) captured by these sensors is stored via an acquisition system 24 into one or more databases 26 provided in the network 10, which databases are then “warehoused” so that they act together as a single database which is here referred to as the Central Emissions Database (CEED) 28. The databases 26 and CEED database 28 are conveniently provided in the form of Oracle databases which are provided off-site of the emitter facilities. This capture and storage of the data from the sensors 20 is carried out in real-time, or near real-time. For the avoidance of doubt, the term “real-time” is here used to mean that data is being continuously captured from the sensors and immediately stored in the databases 26. The CEMS database 1 then makes this stored data, or at least a portion of it, immediately available to the RMO module 2 (described below). In the present embodiment, the RMO module 2 is configured so that any individual emitter can only see/access their own (raw) captured and stored emissions data (as collected from their own CEMS sensors 20), not also all the emissions data captured and stored from other individual emitters CEMS sensors (this is in view of data protection considerations).

The main issue regulators have had with prior art Emissions Trading Schemes has been misstated, inaccurate or uncertain emissions information. The CEMS Database 1 aims to minimise this uncertainty by capturing and storing real-time emissions data measured by the sensors 20 located in the emitting facilities. This cuts costs (compared with prior art systems) by reducing integrity checks associated with verification and introduces confidence to the system.

1.2 RMO (See FIG. 4)

RMO stands for Reporting Monitoring Ordering. The RMO software component 2 of the network 10 is designed to be the one software package that emitters 30 will use to stay compliant to Emission Trading rules, and to carry out real time monitoring and analysis of their own emissions, and reporting to regulators and executing emissions trading orders.

The RMO component effectively comprises the RMO web service server together with individual copies of RMO “client” software, configured for communication and co-operation with the RMO web service server 2 (via a security system/application 27), which are installed in each emitting organisation's (i.e. each emitter's) facilities and are interconnected with each other via the RMO web service server. This effectively provides hierarchical coverage of the organisation facility asset, creating in itself a mini RMO network. This mini RMO network is accessible to Verifiers and Regulators (via the RMO web service server 2) using software module 5 (Verification and Certification component—described below) to ensure compliance and smooth operation of a predetermined Emissions Program which emitters must comply with.

The RMO component 2 accesses the data from the CEMS database 1 and transforms it into meaningful information 29 about what is going on in each emitter firm/installation 30 in terms of emissions e.g. quantity of emissions since a predetermined date or time. The RMO component 2 is capable of performing data analysis, manipulation and management for the installation 30. In this embodiment such analysis and manipulation for any given installation 30 is only carried out by the RMO component when prompted to do so by a user request. The RMO component is provided with sufficient processing speed to carry out such data analysis and manipulation in a very short period of time, preferably substantially instantaneously. Thus, at any given moment in time it is possible for a properly authorised user to immediately find out information representing the current state of emissions at a given emitter facility. When prompted to do so by a user, the RMO component will also produce Reports 31 for internal, external and/or regulatory purposes, and produce company inventories, and will be used to formulate, analyse, monitor and review the organisation's emissions reduction policy. It also contains a portfolio management component, which will be used make order decisions on buying, selling or holding emission allowances.

1.3 CM/RMC (See FIGS. 5 and 6)

The Central Monitoring (CM) component is represented by two boxes 3a,3b in FIG. 1. This software component is designed for use by Regulators 40. These Regulators may, for example, be individual EU Member State Regulators and may include a central regulator in Brussels, Belgium. The CM component 3a,3b interacts with the RMO component 2 to monitor and report emitter compliance with predetermined emissions licensing conditions 42 stored in a memory (not shown) of the network. The CM component is configured 43 to carry out automatically an integrity check and issue a warning, in the form of a warning letter or email alarm/warning 45, to an emitter who is detected to be failing to comply with predetermined emissions conditions (e.g. if the emitter is detected to have exceeded a predetermined level of emissions). The CM component also interacts with the itet Auction component (described below) 6 to send information relating to emissions allocations 44 (of the emitters 30 being monitored) to the Auction component, where the CM component calculates there are emissions allocations 44 available for auction.

The CM component is also configured to perform the administrative function 50 of automatically notifying emitters of their emissions Allowances/Credits with reference to an EU emissions Registry 52 (not forming part of the itet software network 10, but with which the network 10 can communicate e.g. download information) and further includes a permitting function 54 for administering (e.g. issuing permit applications, and issuing and revoking) permits.

FIG. 6 gives a programming level breakdown of the function of the CM component 3. The CM component 3 comprises a plurality of RMC portions (in this embodiment there are three such portions 100,101,102), each one for carrying out monitoring functions in relation to a respective jurisdiction A,B,C (these may, for example, be different geographical jurisdictions). Each such RMC portion 100,101,102 uses respective RMO summary data 110,111,112 obtained from the RMO component 2, which as afore-described is effectively a mini-network of RMO client software modules (running in individual emitter facilities), all linked together via the RMO web server 72.

1.4 E-Market

The E-Market component 4 is a software component used to bring buyers and sellers together, to execute trades and at least receive initial orders from the RMO mini-network users. It is targeted to the trading arm of emissions trading.

Once the RMO mini-network users have performed portfolio analysis on their system they may then choose to make an order. This order is communicated to the E-Market component 4 and market trading takes over. Hence it will be to the benefit of the emitter if their emissions brokers can access and communicate with the E-market component 4.

1.5 VC (See FIG. 7)

VC stands for Verification and Certification. The VC component 5 is a software component targeted at Verifiers and Certifiers of scheme emitters' emission data, reports and project credits, for example verifiers such as the United Kingdom Accreditation Service (UKAS), the leading verification and accreditation body in Europe. Verifiers 60 using itet VC component 5 can easily access remotely emissions data and information managed by the emitters' RMO software (via the RMO component 2) because its part of the itet network, and checks can be performed through the verifiers' VC software. Verifiers sometimes need to go on site at the emitter facilities to verify and audit the firm's emissions record. The VC component 5 is also designed to assist the Verifier 60 in the processes and procedures involved in this e.g. by enabling some verification/auditing to be performed remotely (i.e. off-site). As illustrated in FIG. 7, the VC component 5 is configured to carry out an Emissions data verification process 61, a verification decision making process 62, and to receive/process complaints and disputes 63.

1.6 Auction

Emissions allowances in an Emissions Trading Scheme may be allocated through planning and free allocations. The alternative is allocation by auction. The itet Auction module 6 is designed to assist Regulators 40 to allocate allowances by auction if the need should arise. The Regulators 40 hold information specifying European Emissions Allowances 13 which they use to control/allocate emissions allowances for emitters. Though a certain allocation of the set emissions allowance (for a country/region) is reserved for new entrants to the emissions market, the unreserved amount is allocated by auction. The Auction module 6 is configured to allow Regulators to auction expediently the unreserved emissions allowances available for auction, within the itet network 10.

1.7 TIPS/PIW

The EU Directive requires that the Emissions Trading Scheme be transparent and information be easily open to the public. We propose that the best way to achieve a high degree of openness is through the internet (i.e. the World Wide Web). The itet public information website component 7 of the network 10 is configured to provide an articulate website of news, information and catalogue style content. One portion 7a of the website (the “TIPS” portion) is used to provide catalogued information to all emitters on all emissions abatement technology in the market and expert advice to help them meet emissions reduction. Another portion 7b (the “PIW” portion) of the website provides information to the public about the EU-ETS operation, aimed to deliver transparency and information.

The above-described seven components 1-7 form a European backbone 12 of the itet network system 10. However it will be appreciated that the network 10 may be extended to include an International backbone 14 designed along similar lines, serving one or more International emissions markets and which may or may not interact on a day-to-day basis with the European backbone 12.

The web server portions of the above-described software modules/components 1-7 are programmed into the working memory of a hardware main server system which may be physically located in any suitable location. In the present embodiment the main server system is physically located in an office or other location off-site of any of the emitter facilities that it monitors. This main server system communicates with computer systems installed in the emitter facilities via the internet (i.e. the World Wide Web). The skilled person will readily appreciate that this can be achieved through the use of standard commercially available hardware/network equipment such as, for example, servers from Dell Inc. and network equipment from Cisco systems Inc.

FIG. 8 is a schematic overview of the relationship between various components of the network 10, at programming level. As shown in FIG. 8, the web servers 71,73,74,75 supporting the software components/modules 1,3,4,5 respectively are each in communication with the web server 72 supporting the RMO component via respective communication links C1, C3, C4, C5 to the RMO web service server. The RMO web server 72 communicates with the RMO client software 80, which is formed from individual (or “mini”) RMO client software modules 81,82,83, etc provided in the respective individual emitter facilities connected to the network, so as to effectively network all the mini RMO client modules 81,82,83, etc together. The CEMS sensors 20, located in the individual emitter facilities are integrated to the network via the patch 90 which encodes the captured sensor data into XML language and stores the thus encoded data into the CEED database 28 (already described above). The CEMS Web server 71 communicates with the CEED database (via XML data queries 92) to retrieve stored emissions data as and when required.

1. An emissions management system comprising a network with a plurality of software modules interconnected such that each software module is able to communicate with at least one other software module, and memory means, wherein at least one software module is an emissions data module configured to: communicate with at least one sensor system collecting real-time emissions data from at least one emitting facility; store emissions data captured from the sensor system in the memory means, and make at least a portion of the stored emissions data available to at least one other software module in the network.

2. An emissions management system as claimed in claim 1 wherein the network comprises a main server system in a first location and supporting said plurality of software modules.

3. An emissions management system as claimed in claim 2 wherein the main server system is configured and/or programmed to communicate with a plurality of remote computer systems running in a plurality of further locations.

4. An emissions management system as claimed in claim 3 wherein at least a portion of one or more of the software modules is programmed into a memory of one or more of said remote computer systems.

5. An emissions management system as claimed in claim 3 wherein at least one or more of said remote computer systems includes a sensor system for collecting real-time emissions data from an emitter facility at its respective location.

6. An emissions management system as claimed in claim 3 wherein the main server system configured to control the flow of data between the remote computer systems.

7. An emissions management system as claimed in claim 1 wherein the plurality of software modules includes a monitoring software module comprising a monitoring system for performing monitoring and analysis of emissions from one or more emitters from which real-time emissions data has been captured and stored by the data emissions software module.

8. An emissions management system as claimed in claim 7 wherein the monitoring module is configured to process the real-time emissions data collected from each emitter so as to identify one or more trends in the emissions of the emitters.

9. An emissions management system as claimed in claim 8 wherein the monitoring module is configured to produce a report on the identified emissions of a said emitter when prompted to do so by a user of the emissions management system.

10. An emissions management system as claimed in claim 9 wherein the monitoring module is configured to display the report(s) on a display screen and/or to print the report(s) and/or to make selected data from the report(s) available to one or more of the other software modules in the network.

11. An emissions management system as claimed in claim 1 wherein the plurality of software modules includes a regulation/compliance software module for monitoring compliance of emitters with emissions regulations and/or for regulating emitters.

12. An emissions management system as claimed in claim 111 wherein the regulation/compliance module is configured to analyse data stored and/or processed by the emissions data and/or monitoring modules to detect emitters who are failing to comply with a predetermined emissions regulation.

13. An emissions management system as claimed in claim 12 wherein the regulation/compliance module is configured to automatically issue a warning to an emitter and/or to issue a penalty charge notice to an emitter who is failing to comply.

14. An emissions management system as claimed in claim 1 wherein the plurality of software modules includes a trading module comprising an electronic emissions trading system for enabling emitters to trade emissions allowances.

15. An emissions management system as claimed in claim 14 wherein the trading module is configured to receive orders from emitters who wish to trade emissions allowances, and to make said orders available for viewing by other users of the system.

16. An emissions management system as claimed in claim 1 wherein the plurality of software modules includes a verification/certification software module comprising a verification and/or certification system for use by verifiers/auditors and/or certifiers of emitters.

17. An emissions management system as claimed in claim 16 wherein the verification/certification module is configured to communicate with the monitoring module to obtain and analyse emissions information relating to one more emitters.

18. An emissions management system as claimed in claim 1 wherein the plurality of software modules includes an auction software module comprising an electronic auction system.

19. An emissions management system as claimed in claim 1 wherein the plurality of software modules includes a website software module comprising an internet website for providing emissions information.

20. An emissions management system as claimed in claim 19 wherein the website module is configured to communicate with the monitoring module so as to extract information about emitter emissions for display to users of the website.

21. A method of providing real-time emissions data relating to at least one emitting facility in a first physical location to a plurality of parties located in a plurality of different physical locations remote from the first physical location, the method comprising: collecting real-time emissions data from at least one emitting facility; uploading at least some of the collected emissions data to a computer network; capturing and storing the uploaded data in a memory means of the network, on a substantially real-time basis; and making at least a portion of the stored information available to said plurality of parties via the network.

22. A method as claimed in claim 21 wherein at least a portion of the stored information is available to one or more predetermined ones of said plurality of parties on a real-time, or substantially real-time, basis.

23. A method as claimed in claim 21 including providing sensor systems to one or more emitting facilities for collecting real-time emissions data from the respective facilities.

24. A method as claimed in claim 21 wherein the network comprises a main computer server system programmed with software code for processing the captured real-time emissions data prior to making it available to the plurality of parties.

25. A method as claimed in claim 21 further including processing the captured real-time emissions data so as to identify failure of an emitter to comply with emissions regulations and automatically issuing a warning and/or penalty charge communication to such an emitter.

26. A method as claimed in claim 21 including processing the real-time emissions data captured from an emitting facility and automatically alerting the emitting facility when emissions exceeding a predetermined threshold value are exceeded, or are about to be exceeded, whereby the emitting facility can reduce its emissions so as to reduce overall greenhouse gas emissions.
